(19) United States
(12) Patent Application Publication
(10) Pub. No.: US 2024/0132415 A1
(43) Pub. Date: Apr. 25, 2024

(54) BIOCHAR HORTICULTURAL SUBSTRATE

(71) Applicant: Sun Gro Holdings Inc., Agawam, MA (US)

(72) Inventor: Ka Yeon Jeong, Powell, OH (US)

(73) Assignee: Sun Gro Holdings Inc., Agawam, MA (US)

(21) Appl. No.: 18/476,735

(22) Filed: Sep. 27, 2023

Related U.S. Application Data
(60) Provisional application No. 63/417,739, filed on Oct. 20, 2022.

(51) Int. Cl. C05F 11/04

(52) U.S. Cl. CPC C05F 11/04

(57) ABSTRACT

In one aspect of the invention there is provided a growing media containing a biochar 10 to 60% by volume blended with other horticultural substrate components such as peat, coir, bark, wood substrate, perlite, compost, etc.

### CROSS REFERENCE TO RELATED APPLICATIONS

This application claims priority to U.S. Provisional Application 63/417,739 filed Oct. 20, 2022, which is incorporated herein by reference in its entirety.

### FIELD OF THE INVENTION

The subject invention relates generally to horticultural substrates or growing media. More specifically, it relates to a growing media that uses biochar as the horticultural substrate component.

### BACKGROUND OF THE INVENTION

Biochar is a solid product of pyrolysis process. In the pyrolysis process, the feedstock is exposed to extremely high temperatures (200 to 1000° C.) in a limited oxygen environment. There is a wide range of feedstock that can be used. The most organic matters are suitable for pyrolysis such as agriculture, forestry, sawmill residuals and animal waste materials. The Pyrolysis process is also one of the more effective methods for Carbon sequestration. As a result, carbon concentration in solid biochar is significantly higher than in the feedstock.

### BRIEF DESCRIPTION OF THE FIGURES

FIG. 1 illustrates biochar materials screened with different screen sizes;

FIG. 2 illustrates the water holding capacity and airspace of peat-based growing media;

FIG. 3 illustrates the air space measurements when peat moss is blended;

FIG. 4 is a table showing plant growth trial results; and

FIG. 5 is a table showing pictures of plant growth.

### DETAILED DESCRIPTION OF THE INVENTION

While the invention is susceptible to embodiments in many different forms, there are shown in the drawings and will be described in detail herein the preferred embodiments of the present invention. It should be understood, however, that the present disclosure is to be considered an exemplification of the principles of the invention and is not intended to limit the spirit or scope of the invention of the embodiments illustrated.

### Use of Biochar

In North America, perlite and processed bark are major aggregate components in professional growing media and consumer products (potting soil and soil amendment). Both components play a critical role to provide a desired aeration and drainage level to a plant root zone.

Biochar materials screened between 0.1 to 30 mm were found to be a suitable growing media aggregates to design seedling/plug mix, greenhouse and nursery crop production mixes. Various biochar materials are known and can be used in the invention.

The physical stability of biochar also provides benefitial values for long-term crop production such as nursery crops, fruit tree, and food production in containers without significant organic matter loss and shrinkage over time.

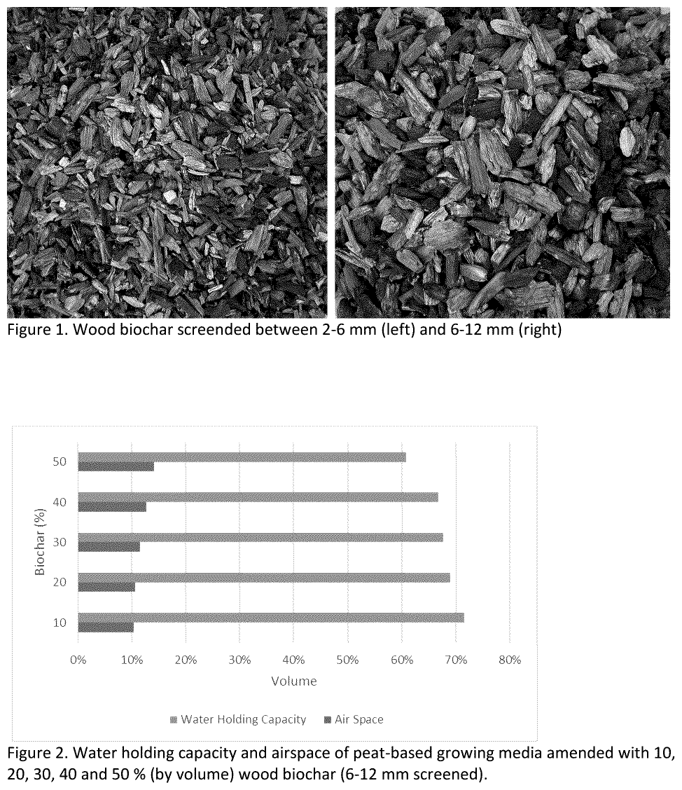

The biochar materials are first screened between 0.1 mm and 30 mm and are suitable to replace growing media components such as perlite, bark, peat, coir, wood substrate, compost, etc (for example, screended 2-6 mm and 6-12 mm, FIG. 1).

As the % of biochar by volume in peat-based growing media increases from 10 to 50%, the air space increases from 10% up to 14% (FIG. 2). The water holding capacity decreased from 72% down to 61% as the % of biochar increases (FIG. 2). Biochar aggregates provides aeration and drainage into horticulture growing media.

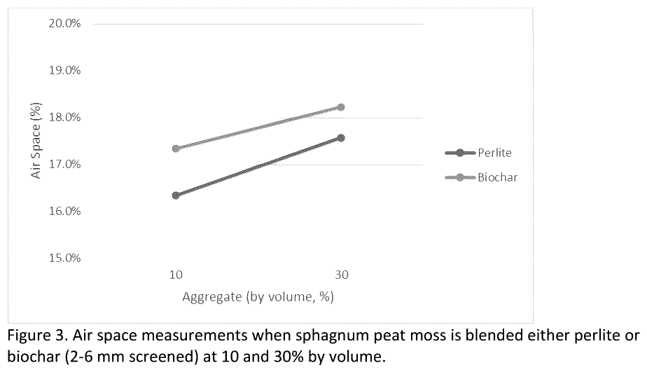

When biochar is blended with sphagnum peat moss from 10 to 30% by volume, the growing media have between 17.3 and 18.2% air space, similar to the rage of 16.3-17.6% airspace with perlite (FIG. 3).

Plant Growth Trial Results

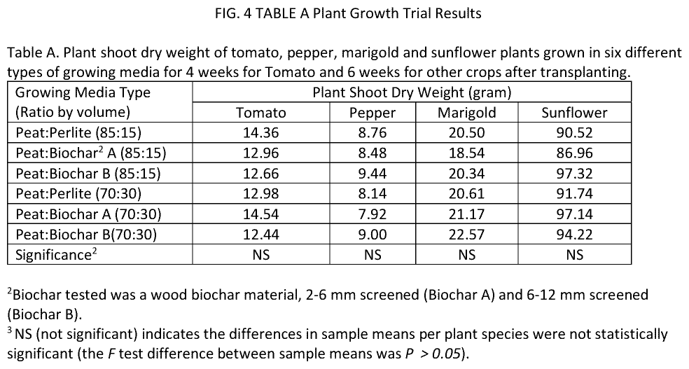

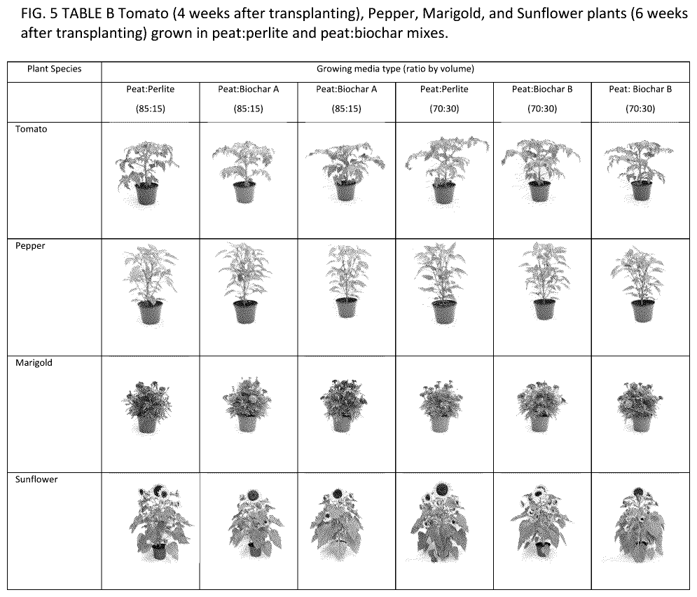

In one embodiment of the invention, seedlings of Tomato ‘Tasmanian Chocolate OG’, Pepper ‘Cupid’, Marigold ‘Queen Sophia’, and Sunflower ‘Teddy Bear’ were transplanted in a 6″ round-plastic container filled with one of six growing media products, FIG. 4. The plant shoot dry weight was measured based on oven-dried plant material harvested 4 weeks after transplanting for tomato plants and 6 weeks after transplanting pepper, marigold and sunflower plants. As a result, both biochar materials (Biochar A: 2-6 mm screened; Biochar B: 6-12 mm screened) performed equally well as perlite in the peat based mixes. The shoot dry weight of plants grown in different growing media types were not statistically different (Table A). Plants grown in all peat: biochar growing media types including two different particle size grades and two ratios (15 and 30%) produced equally high quality plants as plants grown in peat perlite mixes, FIG. 5.

From the foregoing and as mentioned above, it is observed that numerous variations and modifications may be affected without departing from the spirit and scope of the novel concept of the invention. It is to be understood that no limitation with respect to the embodiments illustrated herein is intended or should be inferred.

We claim:

1. A horticultural growing media composition for facilitating plant growth, comprising:
biochar material with particle sizes ranging from 0.1 to 30 mm, selected from various biochar materials;
a volume percentage of said biochar material in the horticultural growing media composition ranging from 10% to 60%;

2. The horticultural growing media composition of claim 1, wherein the biochar material is selected from biochar materials screened to a size range between 0.1 mm and 30 mm.

3. The horticultural growing media composition of claim 1, wherein the volume percentage of the biochar material is in the range of 10% to 60%.

4. The horticultural growing media composition of claim 1, further comprising organic matter to enhance the nutrient-retention capacity of the composition.

5. The horticultural growing media composition of claim 1, wherein the composition is specifically adapted for use in hydroponic system and greenhouse and nursery crop production mixes.

6. The horticultural growing media composition of claim 1 further comprising:
Sphagnum peat moss, blended with said biochar material, in a volume percentage ranging from 10% to 30%; and
providing an air space in the horticultural growing media composition ranging between 16% and 18%, thereby promoting aeration and drainage characteristics comparable to perlite in professional growing media.
